(19) United States
(12) Patent Application Publication
(10) Pub. No.: US 2005/0156414 A1
(43) Pub. Date: Jul. 21, 2005

(54) Curtain airbag device

(75) Inventors: Atsushi Noguchi, Moriyama-shi (JP); Tetsu Mitsuo, Nissin-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/013,340

(22) Filed: Dec. 17, 2004

(30) Foreign Application Priority Data
Dec. 19, 2003 (JP) 2003-423083

(51) Int. Cl. B60R 21/22

(52) U.S. Cl. 280/730.2

(57) ABSTRACT

A curtain airbag device substantially prevents warping in the rear portion along the lower edge of the curtain airbag during deployment. As inflation occurs the curtain airbag is deployed downwardly. Gas is introduced into an envelope-shaped cell at a rear portion along the lower edge of the curtain airbag. The internal pressure of the envelope-shaped cell rapidly increases because the envelope-shaped cell has a closed end. The envelope-shaped cell becomes highly rigid and extends along the lower edge of the curtain airbag. Thus, warping is substantially prevented. In addition, a tab is positioned at the rear end of the upper edge of the curtain airbag. The area of the rear end portion of the curtain airbag which overhangs behind the tab is extremely small.

### BACKGROUND

In an automobile provided with a curtain airbag device, a curtain airbag is inflated downwardly along an inner side surface (for example, doors and pillars) of the vehicle cabin in the event that the automobile undergoes a lateral collision or rollover, thereby protecting the head of an occupant and restraining the occupant inside the cabin.

Japanese Patent Unexamined Publication No. 2003-104162 (incorporated by reference herein) discloses a curtain airbag wherein mounting portions for mounting a curtain airbag to a vehicle body are disposed on the upper edge to be spaced apart from each other. The rearmost mounting portion is positioned at the rear end of the curtain airbag. A lower portion of the rear edge of the curtain airbag is provided with no mounting portion so that the lower portion of the rear edge is free and a cell continuously extending from the rear portion along the lower edge to the rear edge is provided. The cell at the rear portion along the lower edge exhibits a function of increasing the rigidity of the lower edge of the curtain airbag when the curtain airbag is inflated.

In Japanese Patent Unexamined Publication No. 2003-104162, the cell (corner cell) at the lower portion along the rear edge of the curtain airbag communicates with other cells at both the upper side and the front side. Therefore, during the inflation and deployment of the curtain airbag, if gas starts to flow into the corner cell at the upper side, the gas flows toward the front side and, if gas starts to flow into the corner cell at the front side, the gas flows toward the upper side. Therefore, it takes a long time required for increasing the gas pressure in the corner cell and the adjacent cells. During this, the lower portion along the rear edge of the curtain airbag which is free relative to the vehicle body may be warped toward the inside of the cabin or toward the opposite side.

### SUMMARY

It is an object of the present invention to provide a curtain airbag device in which a lower portion along a rear edge of the curtain airbag is substantially prevented from being warped during the deployment process and thus the lower portion along the rear edge of the curtain airbag can be quickly deployed rearwardly during the deployment process.

According to an embodiment of the present invention a curtain airbag device is provided. The device includes a curtain airbag to be deployed downwardly along an inner side surface of a vehicle cabin and a gas generator for supplying gas into the curtain airbag to inflate the curtain airbag, wherein a mounting portion for mounting the curtain airbag to the vehicle body is disposed at the rear end portion of the upper edge of the curtain airbag and no mounting portion for mounting the curtain airbag to the vehicle body is disposed on a lower portion of the rear edge so that the lower portion is free, and an envelope-shaped cell with a closed rear end is provided along a rear portion of the lower edge of the curtain airbag.

According to another embodiment of the present invention, an envelope-shaped cell with a closed rear end is provided along a rear portion of the lower edge of the curtain airbag. During the deployment of the curtain airbag, the gas pressure of the envelope-shaped cell rapidly increases. Therefore, during deployment, an inflated cell with high rigidity longitudinally extending along the lower edge of the curtain airbag is rapidly formed at the rear portion of the lower edge of the curtain airbag, thereby preventing the lower portion along the rear edge of the curtain airbag from being warped.

According to yet another embodiment of the present invention, a vertically extending cell with closed lower end is disposed above the envelope-shaped cell. The cell becomes a vertically extending inflated cell with high rigidity, thereby further preventing the rear edge portion of the curtain airbag from being warped.

It is to be understood that both the foregoing general description and the following detailed description are exemplary and explanatory only, and are not restrictive of the invention as claimed.

### BRIEF DESCRIPTION OF THE DRAWINGS

Theses and other features, aspects and advantages of the present invention will become apparent from the following description, appended claims, and the accompanying exemplary embodiments shown in the drawings, which are briefly described as follows:

FIG. 1(a) is a side view showing an undeployed curtain airbag of a curtain airbag device according to an embodiment of the present.

FIG. 1(b) is a side view of the curtain airbag.

FIG. 1(c) is a sectional view taken along a line C-C of FIG. 1(b).

FIG. 1(d) is sectional view taken along a line D-D of FIG. 1(b).

### DETAILED DESCRIPTION

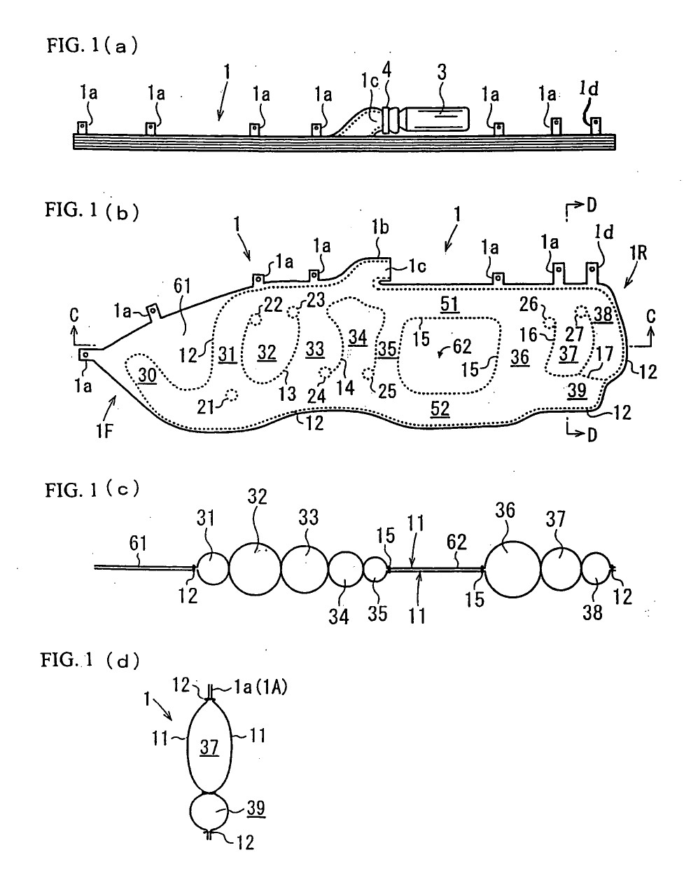

Hereinafter, an embodiment of the present invention will be described with reference to the attached drawings. FIGS. 1(a)-(d) show a curtain airbag device according to an embodiment of the present invention, in which FIG. 1(a) is a side view of the curtain airbag when folded, FIG. 1(b) is a side view of the curtain airbag when inflated and deployed, and FIGS. 1(c) and 1(d) are sectional views taken along lines C-C and D-D of FIG. 1(b), respectively.

In this embodiment, a curtain airbag 1 is disposed along a roof-side portion (boundary portion between the ceiling and the side wall of the vehicle cabin) of an automobile in a state folded into a longitudinally elongate shape. The curtain airbag 1 starts to be inflated with gas from an inflator 3 (gas generator) and is inflated and deployed downwardly along the side wall of the vehicle cabin such as doors and pillars when the automobile undergoes a lateral collision or rollover. Tabs 1a as mounting portions relative to a vehicle body are disposed at predetermined intervals and are fixed to the roof-side portion.

Among the tabs 1a, the rearmost tab id is positioned at rear end portion or very near the rear end of the upper edge of the curtain airbag 1. The tab Id is preferably positioned within 100 mm, particularly 50 mm, from the rear end of the upper edge of the curtain airbag 1.

A projection 1b projecting upwardly is disposed at the middle in the longitudinal direction of the upper edge of the curtain airbag 1 and a gas introduction port 1c is formed in the projection 1b. The tip of the inflator 3 is inserted into the gas introduction port 1c and is fixed by a band 4.

No tab is disposed on the rear edge 1R of the curtain airbag 1 so that the rear edge 1R of the curtain airbag 1 is free, not fixed to the vehicle body except a portion around the uppermost end.

A roof-side garnish, not illustrated, is arranged at the roof-side portion such that the curtain airbag 1 is covered by the roof-side garnish.

For making the curtain airbag 1, two sheets 11 of the same configuration composing two faces which front the side wall of the vehicle cabin and the inner side of the vehicle cabin, respectively, are superposed on each other and the sheets 11 are connected to each other by line-shaped connected portions 12-17 and circular connected portions 21-27 so as to form the inflatable cells 30-39, 51, 52 and the non-inflatable portions 61, 62.

The line-shaped connected portions 12-17 and the circular connected portions 21-27 are obtained by robust connecting means (for example, sewing with high-strength yarns, bonding with high-adhesion adhesives, or welding) capable of tightly connecting the sheets 11 to prevent the sheets 11 from being separated from each other even when the internal pressure of the curtain airbag 1 rises to the upper design limit.

A line-shaped connected portion 12 extends substantially around the periphery of the curtain airbag 1, while, at the front end side IF, the line-shaped connected portion 12 extends downwardly from the upper edge of the front end side IF into a U-like shape, thereby forming a non-inflatable portion 61 along the upper edge of the front end side IF and forming an inflatable cell 30 at the frontmost. The cell 30 is formed in an envelope-like shape which is closed at the front end side.

A line-shaped connected portion 12 also extends along the edges of the projection 1b of the curtain airbag 1 and discontinues across the rear edge of the projection 1b, thereby forming the gas introduction port 1c of the curtain airbag 1.

A line-shaped connected portion 13 is disposed slightly at a front side about the middle of the curtain airbag 1. The line-shaped connected portion 13 is formed in a U-like shape so as to form a cell 32 inside of the U-like shape. The upper portion of the cell 32 communicates with the gas introduction port 1c and the lower portion of the cell 32 is closed. Disposed on the both ends of the line-shaped connected portion 13 are circular connected portions 22, 23.

A vertically extending inflatable cell 31 is defined between the line-shaped connected portion 13 and a curved portion of the line-shaped connected portion 12 at the front side of the curtain airbag. The upper portion of the vertical inflatable cell 31 communicates with the gas introduction port 1c and the lower portion of the vertical inflatable cell 31 communicates with the lower portions of the inflatable cell 30 and an inflatable cell 33 described later. A circular connected portion 21 is disposed to limit the thickness around the lower portion of the cell 31 when inflated not to make the thickness too large.

A line-shaped connected portion 14 formed in an inverted U-like shape is disposed around the middle in the longitudinal direction of the curtain airbag 1 so as to form a cell 34 inside of the inverted U-like shape. The lower portion of the cell 34 communicates with the lower portions of the cells 33, 35 and the upper portion of the cell 34 is closed. Disposed on the both ends of the line-shaped connected portion 14 are circular connected portions 24, 25.

Defined between the line-shaped connected portion 14 and the aforementioned line-shaped connected portion 13 is a cell 33. The upper portion of the cell 33 communicates with the gas introduction port 1c.

A line-shaped connected portion 15 is disposed slightly behind the center of the curtain airbag 1. The line-shaped connected portion 15 extends around into a substantially square shape. The upper side and the lower side of the line-shaped connected portion 15 are spaced apart from the line-shaped connected portion 12 at the upper edge and the lower edge of the curtain airbag so as to form an upper horizontally long inflatable cell 51 and a lower horizontally long inflatable cell 52 between the line-shaped connected portion 12 and the line-shaped connected portion 15 at the upper edge and the lower edge of the curtain airbag, respectively.

Defined between the line-shaped connected portion 15 and the line-shaped connected portion 14 is a vertically extending cell 35. The upper portion of the cell 35 communicates with the front portion of the horizontally long cell 51 and the gas introduction port 1c. The lower portion of the cell 35 communicates with the lower portion of the cell 34 and the front portion of the lower horizontally long cell 52.

The inside of the line-shaped connected portion 15 is isolated from the gas introduction port 1c so that the inside of the line-shaped connected portion 15 is the non-inflatable portion 62 which can not be inflated.

In the rear portion of the curtain airbag 1, a substantially U-like line-shaped connected portion 16 is formed. Disposed on the both ends of the line-shaped connected portion 16 are circular connected portions 26, 27. A line-shaped connected portion 17 is formed to substantially extend in a rear direction from a lower side of the line-shaped connected portion 16.

The rear end of the line-shaped connected portion 17 is connected to the line-shaped connected portion 12 along the rear edge 1R of the curtain airbag.

A cell 37 inside the U-like line-shaped connected portion 16 is formed in an envelope shape of which an upper portion is open and a lower portion is closed.

A cell 38 between the line-shaped connected portion 16 and the line-shaped connected portion 12 along the rear edge 1R of the curtain airbag is also formed in an envelope shape of which an upper portion is open and a lower portion is closed. Defined between the line-shaped connected portions 16, 17 and the line-shaped connected portion 12 along the lower edge of the curtain airbag is a cell 39 formed in an envelope shape which communicates at its front end side with the horizontally long cell 52 and is closed at its rear end side.

When an automobile with the curtain airbag device having the aforementioned structure undergoes a lateral collision or rollover, the inflator 3 generates gas to start the inflation of the curtain airbag 1. The curtain airbag 1 pushes and opens the roof-side garnish and is deployed downwardly.

Since the envelope-shaped cell 39 is closed, the internal pressure of the cell 39 rapidly increases as gas is introduced into the envelope-shaped cell 39 at the rear portion of the lower edge of the curtain airbag 1. Therefore, the envelope-shaped cell 39 becomes an inflated cell with high rigidity extending along the lower edge of the curtain airbag 1. Accordingly, the rear portion of the lower edge of the curtain airbag is substantially prevented from being warped toward the inside of the cabin or the opposite side. The tab Id is positioned at the rear end of the upper edge of the curtain airbag 1 and the area of a rear end portion of the curtain airbag which overhangs behind the tab id is extremely small. Therefore, the rear portion of the curtain airbag is substantially prevented from being warped.

In this embodiment, the vertically extending envelope-shaped cells 37, 38 are provided above the envelope-shaped cell 39, respectively. The internal pressures of the cells 37, 38 also rapidly increase during the inflation of the curtain airbag 1 so that the cells become vertically extending cells with high rigidity, thereby further preventing the rear portion of the curtain airbag from being warped.

The aforementioned embodiment is an example of the present invention and the present invention may take other configurations. For example, the number and the arrangement of cells other than the cell 39 may be different from those of the illustrated embodiment.

Japanese Priority Application 2003-423083, filed Dec. 19, 2003 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A curtain airbag device comprising:
a curtain airbag to be deployed downwardly along an inner side surface of a vehicle cabin; and
a gas generator for supplying gas into the curtain airbag to inflate the curtain airbag, wherein
a mounting portion for mounting the curtain airbag to the vehicle body is disposed at the rear end of the upper edge of the curtain airbag and no mounting portion for mounting the curtain airbag to the vehicle body is disposed on a lower portion of the rear edge, and an envelope-shaped cell with a closed rear end is provided along a rear portion of the lower edge of the curtain airbag.

2. A curtain airbag device as claimed in claim 1, wherein a vertically extending cell having a closed lower end is positioned above the envelope-shaped cell.

3. A curtain airbag device as claimed in claim 2, wherein the vertically extending cell is formed by a first line-shaped connected portion.

4. A curtain airbag device as claimed in claim 3, wherein a circular connected portion is disposed on both ends of the line-shaped connected portion.

5. A curtain airbag device as claimed in claim 2, wherein a second vertically extending cell having a closed lower portion is positioned adjacent to the vertically extending cell.

6. A curtain airbag device as claimed in claim 5 wherein the second vertically extending cell is formed by a second line-shaped connected portion extending in a rear direction from a lower side of the first line-shaped connected portion to a periphery line-shaped connected portion.

7. A curtain airbag device as claimed in claim 6, wherein an upper end of the envelope-shaped cell is formed by the first line-shaped connected portion and the second line-shaped connected portion and wherein the closed end of the envelope-shaped cell is formed by the periphery line-shaped connected portion.

8. A curtain airbag device as claimed in claim 1, wherein the rearmost mounting portion is positioned within 50 mm to 100 mm from the rear end of the upper edge of the curtain airbag.

9. A curtain airbag comprising:
a mounting portion for mounting the curtain airbag to a vehicle body disposed at the rear end of the upper edge of the curtain airbag wherein no mounting portion for mounting the curtain airbag to the vehicle body is disposed on a lower portion of the rear edge, and
an envelope-shaped cell with a closed rear end is provided along the rear end of the lower edge of the curtain airbag.

10. A curtain airbag as claimed in claim 9, wherein a vertically extending cell having a closed lower end is positioned above the envelope-shaped cell.

11. A curtain airbag as claimed in claim 10, wherein the vertically extending cell is formed by a first line-shaped connected portion.

12. A curtain airbag as claimed in claim 10, wherein a circular connected portion is disposed on both ends of the first line-shaped connected portion.

13. A curtain airbag as claimed in claim 10, wherein a second vertically extending cell having a closed lower portion is positioned adjacent to the vertically extending cell and above the envelope-shaped cell.

14. A curtain airbag as claimed in claim 13, wherein the second vertically extending cell is formed by a second line-shaped connected portion extending in a rear direction from a lower side of the first line-shaped connected portion to a periphery line-shaped connected portion.

15. A curtain airbag as claimed in claim 14, wherein an upper end of the envelope-shaped cell is formed by the first line-shaped connected portion and the second line-shaped connected portion and wherein the closed end of the envelope-shaped cell is formed by the periphery line-shaped connected portion.

16. A curtain airbag as claimed in claim 9, wherein the rearmost mounting portion is positioned 50 mm to 100 mm from the rear end of the upper edge of the curtain airbag.

17. A vehicle comprising:
a curtain airbag disposed along a roof-side portion of a vehicle cabin to be deployed downwardly along an inner side surface of the vehicle cabin; and
a gas generator for supplying gas into the curtain airbag to inflate the curtain airbag, wherein
a mounting portion for mounting the curtain airbag to the vehicle body is disposed at the rear end of the upper edge of the curtain airbag and no mounting portion for mounting the curtain airbag to the vehicle body is disposed on a lower portion of the rear edge;
an envelope-shaped cell with a closed rear end is provided along a rear portion of the lower edge of the curtain airbag;
a vertically extending cell having a closed lower end is positioned above the envelope-shaped cell; and
a second vertically extending cell having a closed lower portion is positioned adjacent to the vertically extending cell.

18. A vehicle as claimed in claim 17, wherein the vertically extending cell is formed by a first line-shaped connected portion and a circular connected portion is disposed on both ends of the first line-shaped connected portion.

19. A vehicle as claimed in claim 17 wherein the second vertically extending cell is formed by a second line-shaped connected portion extending in a rear direction from a lower side of the first line-shaped connected portion to a periphery line-shaped connected portion,
wherein the upper end of the envelope-shaped cell is formed by the first line-shaped connected portion and the second line-shaped connected portion and wherein the closed end of the envelope-shaped cell is formed by the periphery line-shaped connected portion.

20. A vehicle as claimed in claim 17, wherein the rearmost mounting portion is positioned 50 mm to 100 mm from the rear end of the upper edge of the curtain airbag.
